(19) United States
(12) Patent Application Publication
(10) Pub. No.: US 2012/0317846 A1
(43) Pub. Date: Dec. 20, 2012

(54) All-Terrain Vehicle

(76) Inventor: Carl Audet, St-Joseph-du-Lac (CA)

(21) Appl. No.: 13/517,722

(22) Filed: Jun. 14, 2012

(30) Foreign Application Priority Data
Jun. 15, 2011 (CA) 2,742,731

(51) Int. Cl. B62D 55/065; E01H 5/06; B62D 11/20

(52) U.S. Cl. 37/266; 180/9.1; 180/9.46; 180/9.23

(57) ABSTRACT

Embodiments of an all-terrain vehicle for ski track setting, military applications, gardening, etc are described herein which include a rear section having a power train and a first set of drive wheels coupled to the power train so as to be driven thereby, a front section having a drive train and a second set of wheels coupled to the drive train so as to be driven thereby; and a universal coupler that attaches the front and rear sections together and that allows free controlled movement therebetween. The drive train of the front section is coupled to the power train so as to be driven thereby. The front section includes a passenger compartment having user controls therein. Tracks are mounted on both set of wheels.

### CROSS-REFERENCE TO RELATED APPLICATION

This application claims the priority of Canadian Patent Application No. 2,742,731 filed Jun. 15, 2011, the subject of which is incorporated herein by reference.

### FIELD

The present disclosure generally relates to all-terrain vehicles. More specifically, the present disclosure is concerned with an all-terrain vehicle adapted to the maintenance of ski slopes and tracks.

### BACKGROUND

All-terrain vehicles that are currently used for the maintenance of ski slopes and tracks are typically provided with front and back pairs of endless tracks mounted on a same frame. The endless tracks aim to provide efficient grip and traction on uneven and/or snowy grounds. A common drawback of such vehicles is the lost of traction when the ground surface is so uneven as to cause one or more tracks or sections thereof to temporarily leave the ground.

To cope with this problem, some all-terrain vehicles have at least their frontal pair of tracks pivotably mounted to the frame so as to allow partial adjustment to the height variation in the ground.

It has been found however that this solution is often insufficient to prevent the tracks from leaving the ground or over spinning, yielding an uneven surface work and increasing the energy consumption of the vehicle.

### SUMMARY

An object of the illustrated embodiments is therefore to provide an improved all-terrain vehicle.

In accordance with an illustrative embodiment, there is provided an all-terrain vehicle comprising:

a rear section having a power train and a first set of wheels coupled to the power train so as to be driven thereby;

a front section having a drive train and a second set of wheels coupled to the drive train so as to be driven thereby; the drive train being coupled to the power train so as to be driven thereby; and

a universal coupler that attaches the front and rear sections together.

Providing an all-terrain vehicle having such front and rear sections, wherein the engine and the passenger compartment are separated on a respective one on the front and rear sections yields a vehicle having a center of gravity which is lower than all-terrain vehicles wherein the engine and the passenger compartment are on a same section of the vehicle. Also, it has been found that such a two-section all-terrain vehicle is stable even when climbing an uneven slope.

According to more specific embodiments, the all-terrain vehicle is provided with motorized wheels on both sections, resulting in increase traction.

Also, providing the passenger compartment on a different section than the engine, yields a passenger compartment wherein sounds emanating from the ski tracks and more generally from the vehicle's surrounding are more audible. The vehicle is therefore safer for the driver's ears and also for any other workers around the vehicle.

Other objects, advantages and features of disclosed embodiments will become more apparent upon reading the following non restrictive description thereof, given by way of example only with reference to the accompanying drawings.

### BRIEF DESCRIPTION OF THE DRAWINGS

FIG. 1 is a side schematic view of an all-terrain vehicle according to an illustrative embodiment; and

FIG. 2 is a top plan schematic view of the all-terrain vehicle from FIG. 1.

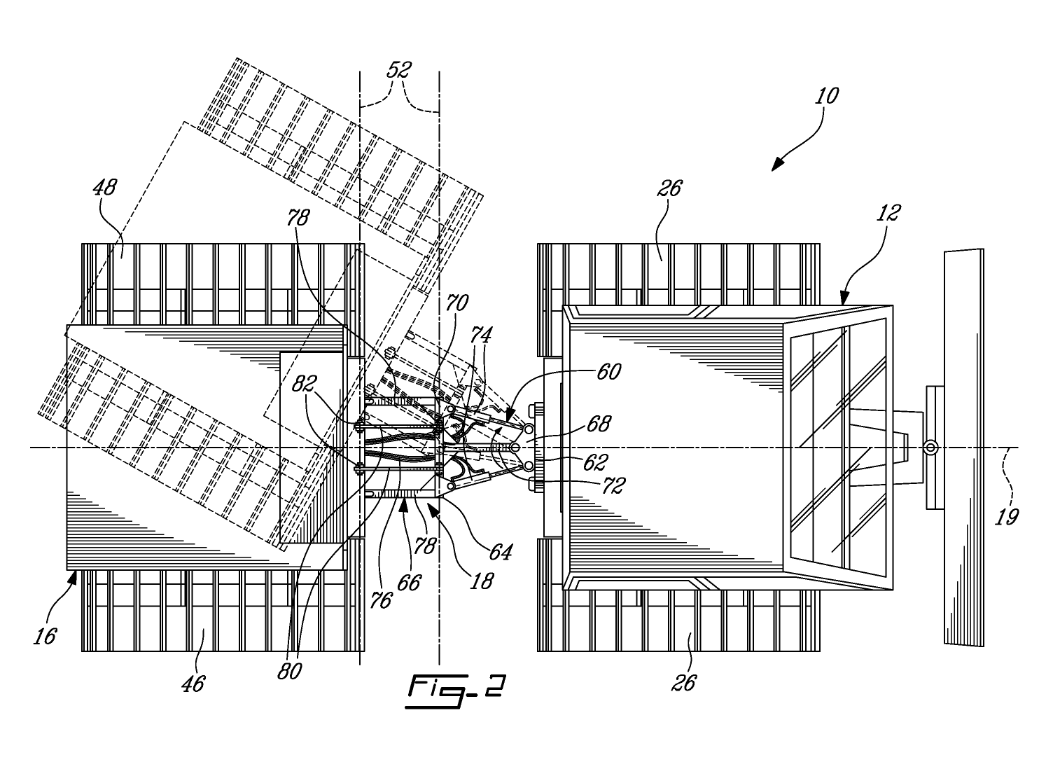

### DETAILED DESCRIPTION

The use of the word “a” or “an” when used in conjunction with the term “comprising” in the claims and/or the specification may mean “one”, but it is also consistent with the meaning of “one or more”, “at least one”, and “one or more than one”. Similarly, the word “another” may mean at least a second or more.

As used in this specification and claim(s), the words “comprising” (and any form of comprising, such as “comprise” and “comprises”), “having” (and any form of having, such as “have” and “has”), “including” (and any form of including, such as “include” and “includes”) or “containing” (and any form of containing, such as “contain” and “contains”), are inclusive or open-ended and do not exclude additional, unrecited elements or process steps.

The expression “drive train” should be construed herein as including the parts, components, assemblies and/or mechanisms provided between an engine and the wheels or tracks.

The expression “power train” is to be construed as to mean a drive train with an engine or motor.

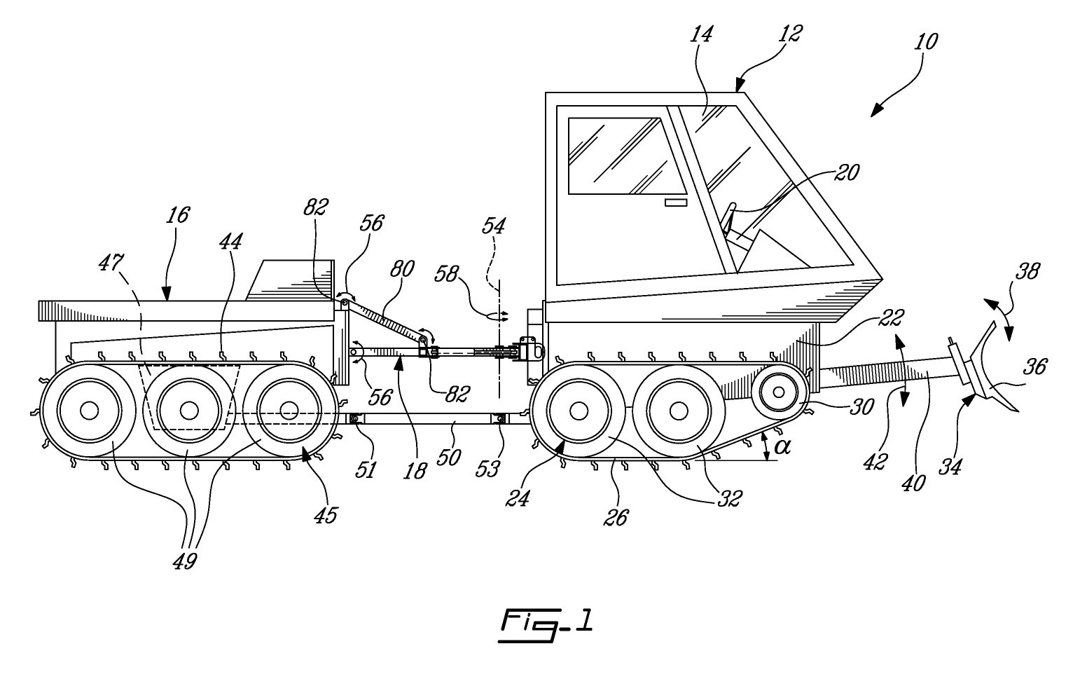

An embodiment of all-terrain vehicle 10 is shown in FIG. 1.

The all-terrain vehicle 10 comprises a front section 12, including a passenger compartment 14, a rear section 16 including the engine and a universal coupling assembly 18 between the front and rear sections 12 and 16 that attaches the front and rear sections 12 and 16 together.

The front section 12 includes a frame 22 to which the passenger compartment 14 is mounted. The passenger compartment 14 comprises conventional commands and controls including a steering wheel 20. Since such commands and controls are believed to be well-known in the art, they will not be described herein in more detail for concision purposes.

The front section 12 further comprises a drive train (not shown) and two lateral first sets of wheels 24 (only one shown) coupled to the drive train so as to be driven thereby. Each set of wheels 24 receives and drives an endless track 26. As will be described hereinbelow in more detail, the drive train of the front section 12 does not include an engine. The drive train of the front section 12 is coupled to a power train (not shown) on the rear section 14 so as to be driven thereby via the coupling assembly 18.

Each of the lateral sets of wheels 24 includes three wheels 30 and 32 that are conventionally mounted to the frame 22 so as to extend therefrom on respective lateral sides thereof.

The diameter of the frontest wheel 30 of each set of wheels 24 is smaller and its axel is positioned higher than the other wheels 32 of the set 24. This yields an angle of attack a between the plane formed by the track 26 between the small wheel 30 and the wheel 32 adjacent thereto and the tangent to the wheels 32. The angle of attack a, which is acute, contributes to help the vehicle 10 climb a steep slope (not shown).

According to other embodiments, the set of wheels 24 is configured differently than illustrated. For example, the diameters of the wheels can be identical. Also the angle of attack a can be different than illustrated.

The front section 12 is equipped with a movable snow plow 34 which is operatively coupled to the drive train via well-know mechanisms. The snow plow includes a plow head 36 which is pivotably mounted onto a support arm 40 (see arrow 38). The support arm 40 is pivotably mounted to the frame 22 (see arrow 42). In addition to its conventional well-known functions, the snow plow 34 serves the additional purpose of adding weight to the front of the front section 12, which contributes to increasing the stability of the vehicle 10, especially in climbing slope.

According to another embodiment, the snow plow is omitted and the frame 22 and/or cabin 14 is provided with additional weight at the front thereof.

The rear section 16 comprises a frame 44, two lateral sets of wheels 45 (only one shown) conventionally mounted to the frame 44 so as to extend on respective lateral sides thereof and receiving respective endless tracks 46 and 48. The wheels 49 of the set of wheels 45 are motorized by a power train that includes an engine 47. In addition to the engine 47, the power train includes transmission and differential elements (not shown) and other conventional components of a power train that allows motorizing the wheels 45 which are operatively coupled thereto.

Even though the set of wheels 45 according to the illustrated embodiment includes three (3) identical wheels, an all-terrain vehicle according to another embodiment of the present invention may include wheels from different sizes or a different number of wheels.

Also, anyone or both of the drive train of the front section and power train of the rear section can be configured so as to power only one or more wheels per set of wheels, the other being idle wheels.

The front and back set of wheels 24 and 45 are mounted to their respective frame via a suspension system (not shown).

According to another embodiment (not shown), one or both sets of wheels 24 and 45 are mounted to the respective frame 22 and 44 via a pivot axle that allows tilt movement of the track thereabout.

Since configurations and operations of drive trains, endless tracks, all-terrain vehicle's commands, and frontal snow plows, are all believed to be well-known in the art, they will not be described herein in more detail for concision purposes.

The universal coupler 18 allows the rear section 16 universal movements with regards to the front section 12. More specifically, the coupling assembly 18 allows the rear section 16 to pivot about axes 52 and 54, which are both perpendicular to the longitudinal axis 19 and also perpendicular relative one another (see respective arrows 56 and 58). The longitudinal axis 19 is parallel to the tracks 26.

The universal coupler 18 comprises a lateral pivot mechanism 60 having proximate and distal ends 62 and 64 and being secured to the front section 12 via its proximate end 62 and an azimuthal pivot mechanism 66 secured to both the lateral pivot mechanism 60 and to the rear section 16 of the vehicle 10 therebetween. The coupler 18 generally lies in a plane leveled with the centre of gravity of the front and rear sections 12 and 16 of the vehicle 10.

The lateral pivot mechanism 60 includes a mounting bracket 68 secured to the back of the frame 22, a frame element 70, a transversal rod 72 secured to the frame element 70 perpendicularly therefrom and pivotably to the mounting bracket 68 therebetween, and two cylinders 74, each pivotably mounted to one end of the frame element 70 and to the mounting bracket 68 for movement about the axis 54 which is perpendicular to the direction of the displacement of the vehicle 10 and to the ground. The cylinders 74 are either pneumatic or hydraulic and are appropriately powered and fed through cables 76 by the corresponding system (not shown) from the vehicle 10 as it is conventionally known.

The azimuthal pivot mechanism 66 includes two rods 78 having one of their longitudinal ends secured to the frame element 70 at a respective end thereof so as to be positioned generally perpendicularly therefrom and their other longitudinal ends mounted to the front of the rear section 16 of the vehicle 10 on a pivot 80 so as to be pivotable about one of the axes 52. The axes 52 are perpendicular to the axis 19 and to the axis 54. The rods 78 generally lie within the same plane than the lateral pivot mechanism 60.

The pivot mechanism 66 further includes two stability arms 80 which are both mounted to the frame element 70 and to the front of the rear section 16 via a pivot 82 at each end so as to allow pivot movement of the ends of the arms 80 about the axes 52.

In operation of the vehicle 10, the coupling assembly 18 allows the rear section 16 of the vehicle 10 to define a wide range of angles with the front section 12 on broken ground without the front and rear sections losing traction. The azimuthal pivot mechanism 66 allows free movement of the rear section 16 relatively to the front section 12 with regards to the axes 52. The cylinders 74 of the motorized lateral pivot mechanism 60 are powered by the power train and actuated in response to the steering wheel 20.

A coupling shaft 50 is provided between the front and rear sections 12 and 16 that operatively couples the drive train of the front section 12 with to the power train of the back portion 16 so that part of the force produce by the engine 47 is transferred to the drive train of the front section 12. The coupling shaft 50 includes two joints 51 and 53 that allow the shaft 50 to pivot between respectively axes 52 and 54. The joints 51 and 53 are respectively registered with a respective one of the axes 52 and 54 for pivot movements in unison therewith.

All the elements of the assembly 18 which are not pivotably mounted to another element are secured for example by welding or using fasteners.

The lateral and azimuthal pivot mechanisms 60 and 66 are not limited to the illustrated embodiments. Other mechanisms or assemblies can be provided between the front and rear sections 12 and 16 that allow their attachment together and their free relative movement. Also, their positions can be reversed with regards to the front and rear sections 12 and 16.

It is to be noted that many modifications could be made to the all-terrain vehicle described hereinabove and illustrated in the appended drawings. For example:

the endless tracks can be replaced by tires, or more generally wheels;

the number of wheels on each side of each of the front and rear sections may be different than three;

the configuration of the tracks can be different than those illustrated;

the snow plow can be omitted or replaced by another equipment;

the rear section can be provided with a conventional PTO (Power Take Out);

the passenger compartment can be omitted and the resulting vehicle being configured for example for remote control. In such a case, additional sensors, such as for example proximity sensors, etc. can be provided as safety features; and

the shaft between the front and rear sections and that operatively couples the drive train of the front portion to the power train of the rear section can further acts as the universal coupler, wherein any devices or mechanisms that attaches together the front and rear section and that allow universal movement therebetween is omitted;

the vehicle may further include additional sections, each having their respective drive train and set of wheels coupled to the drive train so as to be driven thereby. Such an additional section is coupled to the rear section so as to be trailed thereby and has its drive train coupled to the power train so as to be driven thereby;

further equipments or machineries can be attached to the rear section so as to be trailed by the vehicle 10.

Applications of an all-terrain vehicle according to embodiments of the present invention include ski or snowmobile track setting, military applications, gardening, etc.

While several embodiments have been described herein, it will be understood that further modifications are possible, and this application is intended to cover any variations, uses, or adaptations of the disclosed embodiments, following in general the principles thereof and including such departures from the present disclosure as to come within knowledge or customary practice in the art to which the invention pertains, and as may be applied to the essential features hereinbefore set forth and falling within the scope of the invention.

What is claimed is:

1. An all-terrain vehicle comprising:
a rear section having a power train and a first set of wheels coupled to the power train so as to be driven thereby;
a front section having a drive train and a second set of wheels coupled to the drive train so as to be driven thereby; the drive train being coupled to the power train so as to be driven thereby; and
a universal coupler that attaches the front and rear sections together.

2. A vehicle as recited in claim 1 further comprising a coupling shaft for transmitting part of the power capacity of the power train to the drive train.

3. A vehicle as recited in claim 2, wherein the coupling shaft includes two axel joints.

4. A vehicle as recited in claim 1, wherein the universal coupler is configured for both azimuthal and radial relative movements between the front and rear sections.

5. A vehicle as recited in claim 1, wherein the universal coupler includes azimuthal and lateral pivot axels.

6. A vehicle as recited in claim 5, wherein the lateral pivot axel is responsive to steering commands.

7. A vehicle as recited in claim 5, further comprising a coupling shaft for transmitting part of the power capacity of the power train to the drive train; the coupling shaft including two axel joints, each registered with a respective one of the azimuthal and lateral pivot axels of the universal coupler for pivot movements in unison therewith.

8. A vehicle as recited in claim 1, wherein the front section is provided with a snow plow.

9. A vehicle as recited in claim 8, wherein the snow plow is movable and motorized.

10. A vehicle as recited in claim 1, wherein the front section further comprises a passenger compartment.

11. A vehicle as recited in 1, wherein the first set of wheels includes two rear lateral sets of wheels and the second set of wheels includes two front lateral sets of wheels.

12. A vehicle as recited in claim 11, wherein each of the two rear lateral sets of wheels and of the two front lateral sets of wheels receives and drives an endless track.

13. A vehicle as recited in claim 12, wherein each of the two front lateral sets of wheels are configured so that the endless track is provided with an angle of attack.

14. A vehicle as recited in claim 1, wherein at least one of the first and second sets of wheels includes both drive and driven wheels.

15. A vehicle as recited in claim 1, wherein the drive train is a first drive train; the vehicle further comprising a third section having a second drive train and a third set of wheels coupled to the second drive train so as to be driven thereby; the third section being coupled to the rear section so as to be trail thereby; the second drive train being coupled to the power train so as to be driven thereby.
